(19) United States
(12) Patent Application Publication
(10) Pub. No.: US 2007/0023443 A1
(43) Pub. Date: Feb. 1, 2007

(54) Differentiated vending indicia and methods

(76) Inventor: Anthony Huffman, Newport Beach, CA (US)

Correspondence Address: CAROL WILSON;BP AMERICA INC., MAIL CODE 5 EAST, 4101 WINFIELD ROAD, WARRENVILLE, IL, 60555, US

(21) Appl. No.: 11/444,654

(22) Filed: Jun. 1, 2006

Related U.S. Application Data
(60) Provisional application No. 60/692,831, filed on Jun. 22, 2005.

(51) Int. Cl. G07F 11/00

(52) U.S. Cl. 221/2

(57) ABSTRACT

Systems for influencing a purchasers vending decision through the use of sensory differentiated product indicia are disclosed. Methods for activating sensory differentiated product indicia in response to available inventory also are disclosed.

### RELATED APPLICATIONS

This application is entitled to and hereby claims benefit of the filing date for U.S. Provisional Application Ser. No. 60/692,831, filed Jun. 22, 2005.

### FIELD OF THE INVENTION

The invention relates to apparatus and methods useful in vending or in other applications where customer preferences can be influenced by production selection indicia. More particularly the invention relates to the use of unique indicia which correspond to products to be vended, and to apparatus and methods which can be used to increase the likelihood that a potential consumer will select a particular product to be vended.

### BACKGROUND OF THE INVENTION

Vending machines typically provide a wide range of product choices to potential customers. Many vending machine customers first make their buying decisions at the vending machine, or change their mind about what product to purchase while pondering the choices presented in the vending environment.

Because a customer's vending decision often is made in the vending environment, the customer frequently subconsciously or consciously looks to the vending machine for cues as to what product to purchase. Typically, a vending machine will provide information such as a placard or other information corresponding to a particular product. This arrangement is common in the vending of food products such as candy bars, pretzels and chips, where the product is viewed directly through a glass display case with selection information displayed adjacent to the product. Alternatively, a placard corresponding to a product is used, or placed adjacent to an actuator used to select the product, such as the trigger of a fountain machine dispensing valve corresponding to a particular drink selection.

Typically indicia consist of a plurality of placard or other media displaying a product name and colorful logo. Unfortunately, a variety of these relatively similar indicia on a vending machine does little to induce the purchase of a particular product from a vending machine, and does little to differentiate a single product offering from other offerings in the same machine. What is needed are indicia and methods which can better influence a customer to preferentially select, and in some cases continue to select, a particular vending offering from a number of offerings available from a given machine.

### SUMMARY OF THE INVENTION

I find that customer buying decisions can be favorably influenced by enhancing the product indicia for particular vending offerings in ways not previously exploited in the vending machine environment.

In a first embodiment of my invention, a vending system includes a first and second dispensing means for vending a first or second product in response to a customer selection, a first and second product selection means corresponding to the first and second dispensing means such that a customer actuation of the first or second customer selection means causes the corresponding first or second product to be vended, and at least one sensory differentiated product indicia associated with at least one of the first or second product selection means for influencing the customer selection of the first or second product.

As used in this application the term “vending system” or “vending machine” means any machine or system which provides one of a number of products to a person who has indicated a preference for that particular product. Examples of machines and systems includes fountain machines, machines for dispensing frozen carbonated beverages, cigarette vending machines, candy machines and the like.

“Sensory differentiated product indicia” means indicia that are different from other indicia used in the same vending machine or vending machine environment in a manner greater than the mere presentation of product information, logos or trademarks. Thus, a sensory differentiated product indicium can be a visually differentiated indicium, aurally differentiated indicium, tactilely differentiated indicium, or olfactory differentiated indicium. Such differentiation can be used in combination to provide highly differentiated information corresponding to a particular type of product. As used herein, an “indicium” is a proxy for a product or its characteristic useful in influencing a vending selection, where that proxy is independent of the product and independently alterable without changing the product, such as items associated with an actuator button or panel, not a characteristic of the product itself, such as the smell of the actual product or a display of the actual product.

Where indicia are visually differentiated, the indicia provide a visual cue to the customer that goes beyond a mere product logo or product name. Such visually differentiated indicia can include a three dimensional surface, such as might be presented by a topographical surface or a billeted aluminum type of surface, a lens that provides a visual effect different from that normally presented by a two dimensional surface such as an optical lens or a hologram, a substrate having unusual properties such as a reflective foil, or indicia incorporating flashing lights or a changing LCD display. In each case, the visually differentiated indicia provide some visually differentiating element beyond product logos or names that are often provided on a two dimensional printed or painted display.

Where indicia are tactilely, aurally or olfactory differentiated, they also provide differentiation from a two dimensional printed or painted product indicia, such as by three dimensional surfaces that feel differently (tactile) or by emitting sounds (aural).

The invention is particularly useful in connection with the vending of liquids such as with a fountain machine used in a convenience store. In this embodiment, a system for dispensing one of at least two different liquid products in response to a customer selection includes a first and second dispenser for dispensing a first or second liquid product in response to a customer selection, a first and second product selector corresponding to the first and second dispenser such that a customer actuation of the first or second customer selection means causes the corresponding first or second liquid product to be vended, and at least one sensory differentiated product indicium associated with the first or second product selection means for influencing the customer selection of the first or second product. The use of at least one, and preferably two or more, sensory differentiated indicia provide stronger, more particularized cues to the customer that can influence the current buying decision between at least two products available from a single vending machine, as opposed to attracting non-specific attention to the machine itself.

Product selectors can be any device capable of indicating a person's desired selection to a dispensing apparatus, such as a button, a lever, a keyboard, interruption of a photoelectric cell, a voice recognition system or the like that is indicated as corresponding to a desired action such as the vending a desired drink or food product.

As used in this application the term “fountain machine” means a machine for vending a plurality of drinks and at which a customer manually actuates an actuator to select such a drink, such as by pressing a button or engaging a vessel for receiving the drink against an actuator lever, or activating other mechanical, electrical or opto-electrical devices intended to signal the customer's choice of a particular drink to the fountain machine.

In some embodiments, the invention is incorporated into a fountain valve of various types. As used in this application, the term “fountain valve” means the portion of a fountain machine that a customer uses to select a beverage and the portion of the machine downstream from internal product selection valves or the like that cause a selected beverage to be dispensed. For example, a fountain valve can be of the type where a cup is placed beneath a nozzle and which dispenses a selected liquid in response to a user actuated button on the fountain machine. Alternatively, the fountain valve can include an actuator that dispenses liquid when a cup or other receptacle is pushed against the lever, causing a liquid to flow into the cup. In either case, the fountain valve is meant to include the customer selected actuator and the mechanism, ending in the nozzle, that dispenses the selected liquid into the customer's cup.

### BRIEF DESCRIPTION OF THE DRAWINGS

FIG. 1 illustrates a fountain machine having a plurality of sensory differentiated in accordance with the present invention.

FIGS. 2 through 9 illustrate several different types of sensory differentiated indicia in accordance with the present invention.

### DETAILED DESCRIPTION OF THE INVENTION

While the invention can be used in any vending environment, the following detailed description illustrates how the invention can be used in connection with a fountain machine to encourage customers to select a particular product from a number of liquid products available from the machine. Those skilled in the art of vending will recognize how the invention can be used in other contexts such as vending of snack products and the like, and the scope of our invention is therefore intended to be limited only by our claims.

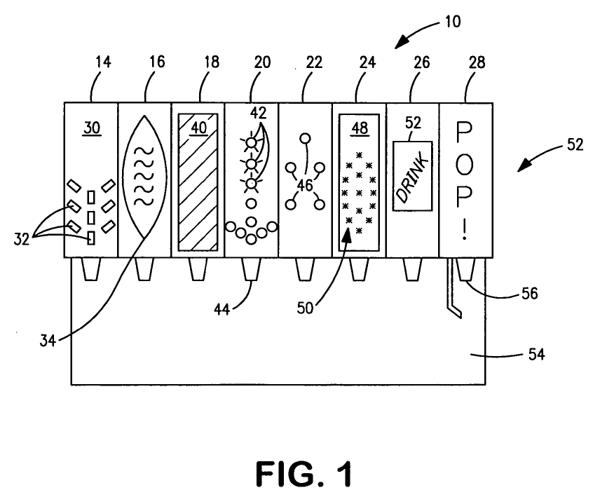

FIG. 1 depicts a fountain machine 10 capable of dispensing eight different fountain drinks in response to a selection made by a customer. Machine 10 includes a housing 12 that includes the necessary mechanisms to provide for properly mixed carbonated fountain drinks. These mechanisms (not shown) can be of a wide variety of types known in the art, such as those disclosed in U.S. Pat. No. 6,421,583, the disclosure of which is hereby incorporated by reference.

Machine 10 includes eight sensory differentiated product indicia 14, 16, 18, 20, 22, 24, 26 and 28 corresponding to eight different liquids which can be dispensed from the fountain machine. The indicia are placed over fountain valve actuator buttons (not visible) which will dispense the selected beverage from the corresponding nozzle when the actuator button is pressed by the fountain drink customer.

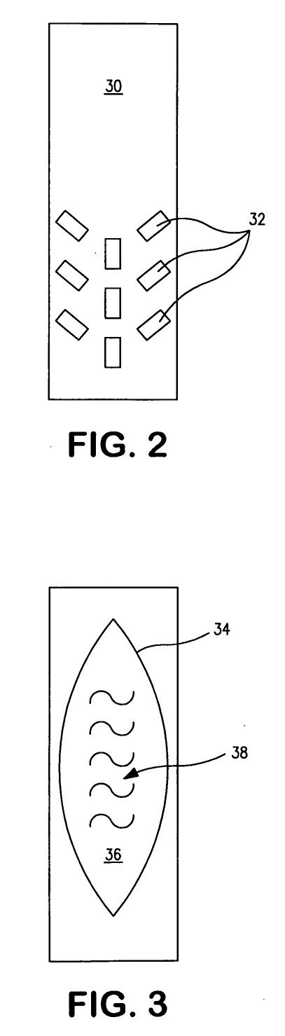

Indicium 14, shown in greater detail in FIG. 2, is a visually and tactilely differentiated indicium which provides a three dimensional surface 30 with raised potions 32 provide the appearance of billeted aluminum of the type frequently found on off road vehicles. Surface 30 provides both a look and feel to the indicium that is pleasing to the customer and reminiscent of a product that can be associated with its differentiation. For example, the billeted aluminum appearance common to off road vehicles might be favorably associated by youthful, outdoors-oriented customers with an outdoor drink meant to replenish fluids, vitamins and minerals after strenuous physical activity.

Indicium 16, shown in greater detail in FIG. 3, includes a lens 34 placed over a placard 36 that includes a visually interesting design 38. The lens 34 changes the appearance of a design 38 depending on the angle of viewing, causing a potential customer to dwell in the changing appearance and subconsciously or consciously consider selecting the product associated with indicium 16. This is another example of a visually differentiated indicium, with the holographic lens providing a visually differentiated element and appeal beyond that provided by typical logo bearing signage.

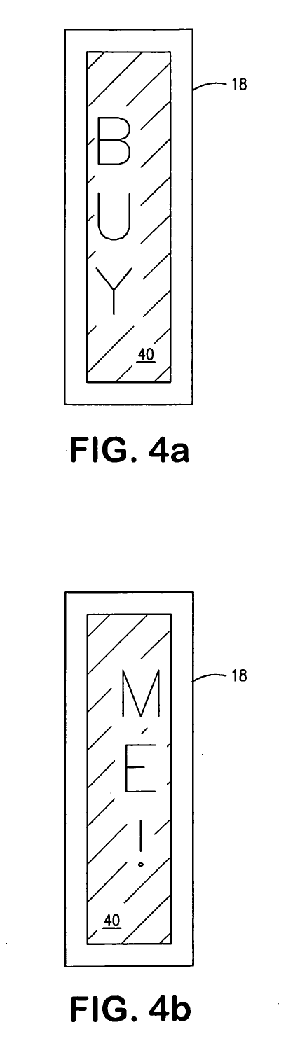

Indicium 18, shown in detail in FIG. 4a, includes a plastic hologram 40. Hologram 40 presents two different messages depending on the angle of viewing, as shown in FIGS. 4a and 4b. As with indicium 16, the appearance of indicium 18 is visually differentiated from the other indicia used on machine 10, causing customers to dwell more closely on the indicia and possible influence their product selection.

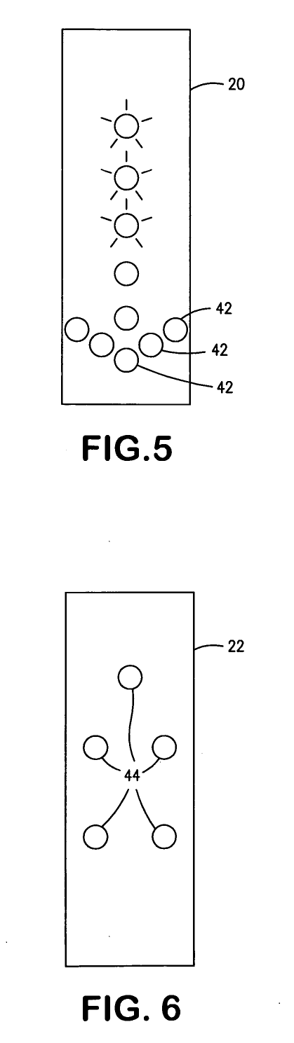

Indicium 20, shown in more detail in FIG. 5, incorporates flashing light emitting diodes (LEDs) 42 of multiple colors that flash in a pattern calculated to draw interest to indicium 20 and its corresponding product, in this case a timed pattern moving from the top of indicium 20 toward the bottom of indicium 20 in the direction of a nozzle 44 (see FIG. 1).

FIG. 6 illustrates visually and aurally differentiated indicium 22 that include elements of sound and light to draw attention to the product corresponding to indicium 22. Indicium 22 includes five LEDs 44 that pulsate at the same time a sound or other purchase inducing message is audibly emitted from machine 10. The use of combined visual and aural differentiation provides the benefit of stimulating two senses, as flashing LEDs 44 form a mental connection between the sound and indicium 22. Without the simultaneous use of sound and light, it would be difficult to tie the sound to indicia. Locating LEDs 44 on indicia 22 facilitates locating a sound emitting means (not shown) within housing 12, eliminating any need to try to localize the emission of aural stimuli to indicia 22, and facilitating the use of a common sound system in connection with multiple indicia.

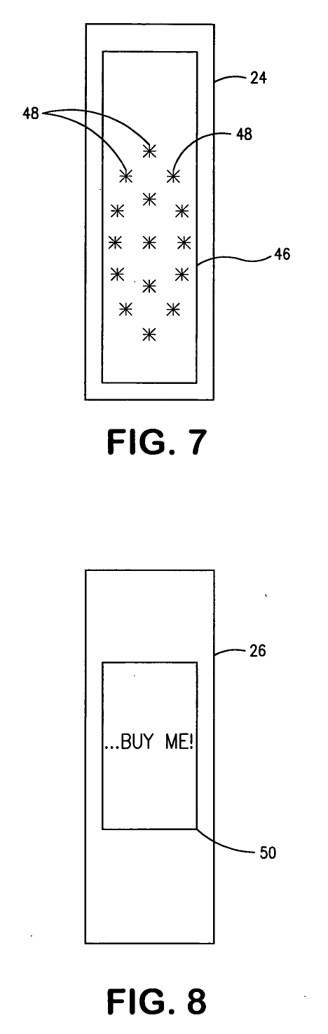

Indicium 24, shown in greater detail in FIG. 7, is a plastic layer 46 which incorporates highly reflective artificial diamonds 48 to provide a visually differentiated appearance to indicium 24 that can be associated with a high quality drink product.

FIG. 8 illustrates an inexpensive mini-LED screen 50 which serves as indicium 26. Screen 50 provides a scrolling message associated with product corresponding to indicium 26, again providing additional conscious or sub-conscious stimulation to customers that can cause them to select a drink when they might not have, or to select a drink that is preferred to be vended at a given point in time, either because that drink is being promoted, or possibly because the supply of drink is higher than others provided by fountain machine 10 at that point in time.

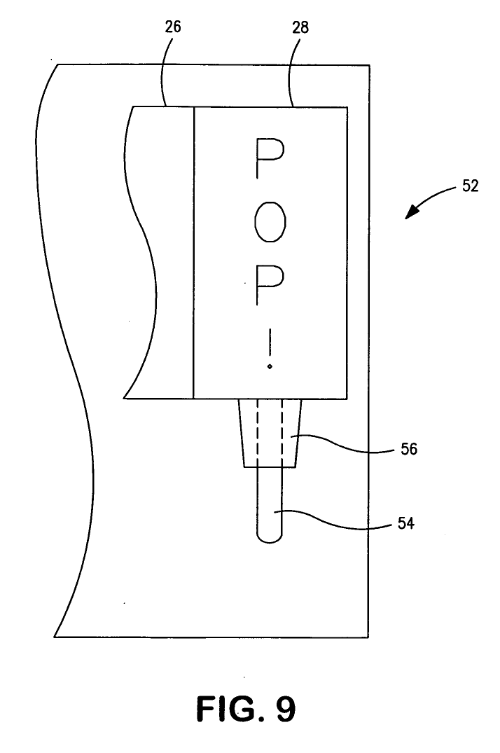

FIG. 9 depicts indicium 28. Indicium 28 appears to be a simple product logo of the type currently found in use on fountain machines. However, indicium 28 is programmed to cause a sound to be emitted from fountain machine 10 in response to a request to vend a particular product. This sound is a sound already associated with the drink product to be dispensed, and thus rewards the selection of the drink. This type of differentiation, referred to in this application as “after the fact” differentiation, rewards the loyalties of customers who have selected the product based on a previous association with the product or knowledge that selection of that product will produce a favorable result. Use of a flashing light and sound in this manner is an example of “after the fact” visual and aural differentiation.

Indicium 28 is associated with a drink station 52 that employs a fountain valve having a cup engaging actuator 54 that causes the selected drink to be dispensed through nozzle 56 by pressing a cup or other receptacle against actuator 54 rather than by touching an indicium that causes drink to be dispensed. Use of a drink station with an actuator lever can provide a particularly enjoyable experience for a customer in that the customer can enjoy the tactile sensation of pushing the lever against the cup to cause the sound and drink to be simultaneously emitted. Depending on the desired result, the sound could be emitted each time the actuator lever is pressed, or only after a desired “fill” volume has been dispensed from nozzle 56, or possibly when the correct fill volume has been dispensed form nozzle 56.

In some embodiments of the invention, it may be preferred to use a sensory differentiated indicia for every product available from a machine or device, while in other embodiments it may be preferred only to use sensory differentiated indicia in connection with one or a few products available to elicit a preferential response to new or slow selling products. In any embodiment, it may be preferred to use two or more sensory differentiation techniques in combination to provide more differentiated indicium corresponding to a particular product.

The use of sensory differentiated product indicia can be used to encourage the selection of one or more products manually or in response to electronic control. In its simplest application, a sensory differentiated product indicium can be associated with one or more product selection actuators by manually affixing the indicium to an actuator button or above a station having an actuator associated with a particular product, or selecting actuation of the sensory differentiated product indicium if such capability is included in a vending machine.

Alternatively, indicia can be selected by a vending machine in response to certain conditions, such as low customer traffic, in which case several indicia might be actuated simultaneously to draw attention to one or more available products.

In yet other applications, the vending machine might inventory available products, and for products for which there is an overabundance of supply relative to other products, initiate the use of available sensory differentiated product indicia for the abundant product.

The foregoing methods can be implemented by those of ordinary skill in the art familiar with vending machine control systems, and need not be of any particular type to be used in the invention.

I claim:

1. A system for providing to a customer one of at least two available products comprising:
a first and second dispensing means for vending a first or second product in response to a customer selection:
a first and second product selection means corresponding to the first and second dispensing means such that a customer actuation of the first or second customer selection means causes the corresponding first or second product to be vended; and
at least one sensory differentiated product indicium associated with at least one of the first or second product selection means for influencing the customer selection of the first or second product.

2. The vending system of claim 1 in which a sensory differentiated product indicium employs two or more types of sensory differentiation selected from the group consisting of visually differentiated indicia, aurally differentiated indicia, tactilely differentiated indicia, or olfactory differentiated indicia.

3. The system of claim 1 wherein a sensory differentiated product indicium includes visual and aural differentiation.

4. The system of claim 1 wherein a sensory differentiated product indicium includes tactile and aural differentiation.

5. The system of claim 1 wherein a sensory differentiated product indicium includes visual and tactile differentiation.

6. The system of claim 1 wherein a sensory differentiated product indicium includes visual, tactile and aurally differentiation.

7. The system of claim 1 wherein a sensory differentiated product indicium includes after the fact aural differentiation.

8. The system of claim 1 wherein a sensory differentiated product indicium includes after the fact visual differentiation.

9. The system of claim 1 wherein a sensory differentiated product indicium includes after the fact visual and aural differentiation.

10. The system of claim 1 wherein a sensory differentiated product indicia is activated in response to relative levels of product available to a vending machine.

11. A system for dispensing one of at least two available liquid products in response to a customer selection of one of the at least two products comprising:
a first and second dispenser for dispensing a first or second liquid product in response to a customer selection;
a first and second product selector corresponding to the first and second dispenser such that a customer actuation of the first or second customer selection means causes the corresponding first or second liquid product to be vended; and
at least one sensory differentiated product indicia associated with the first or second product selector for influencing the customer selection of the first or second product.

12. The system of claim 11 wherein the dispenser is a fountain machine capable of dispensing a plurality of liquid products.

13. The system of claim 11 wherein the product selector is a fountain valve for selecting a particular liquid product.

14. The system of claim 11 wherein the dispenser is a fountain machine capable of dispensing a plurality of liquid products and wherein the product selector is a fountain valve for selecting a particular liquid product.

15. The system of claim 11 wherein the fountain valve comprises an actuator that causes a liquid to be dispensed when contacted by a vessel for receiving the liquid, and an outlet for dispensing the selected liquid product.

16. The system of claim 11 wherein the fountain valve comprises an actuator that causes liquid to be dispensed into a vessel when the actuator is physically contacted by a customer, and an outlet for dispensing the selected liquid product.

17. The system of claim 11 wherein a sensory differentiated product indicium is selected from the group consisting of visually differentiated indicia, aurally differentiated indicia, tactilely differentiated indicia, and olfactory differentiated indicia.

18. The system of claim 11 wherein a sensory differentiated product indicium includes visual and aurally differentiation.

19. The system of claim 11 wherein a sensory differentiated product indicium includes visual and tactile differentiation.

20. The system of claim 12 wherein a sensory differentiated product indicium is activated in response to relative levels of materials available to the fountain machine.

21. The system of claim 12 wherein a sensory differentiated product indicium includes visual and tactile differentiation, and at least one of the visual and tactile differentiation is after the fact differentiation.

22. The system of claim 11 including a visually and tactilely differentiated product having the appearance and feel of a billeted plate.

23. The system of claim 11 in which at least two sensory differentiated product indicia are used.

24. The system of claim 23 in which at least two sensory differentiated product indicia each employ at least two different types of differentiation selected from the group consisting of visual types, oral types, tactile types, and olfactory types.

25. A process for using sensory differentiated product indicia to preferentially sell products in accordance with available supply in a vending machine comprising the steps of:
inventorying the amount of two or more products that can be vended by the vending machine; and thereafter
initiating a sensory differentiated product indicia in response to the inventory of products that can be vended by the machine, thereby promoting the dispensing of a product in response to product inventorying.

26. The process of claim 25 where a sensory differentiated product indicium is activated to promote the sale of a product having a greater inventory than desired.

27. The process of claim 25 where a sensory differentiated product indicium is activated to promote the sale of a product having a lesser inventory than desired, to more quickly deplete the inventory of the product.
